(19) United States
(12) Patent Application Publication
(10) Pub. No.: US 2026/0221918 A1
(43) Pub. Date: Jul. 30, 2026

(54) Method and Device for Operating an Electrical Machine in an Emergency Operating Mode

(71) Applicant: Bayerische Motoren Werke Aktiengesellschaft, Muenchen (DE)

(72) Inventors: Said EL-BARBARI, Freising (DE); Igor GUSYEV, Haar (DE); Jovan KNEZEVIC, Muenchen (DE)

(21) Appl. No.: 19/142,822

(22) PCT Filed: Dec. 20, 2023
(86) PCT No.: PCT/EP2023/086950

§ 371 Date: Jun. 24, 2025

(30) Foreign Application Priority Data
Jan. 17, 2023 (DE) 10 2023 101 004.2

(51) Int. Cl. H02P 25/026; H02P 23/06; H02P 23/14; H02P 25/028; H02P 27/06

(52) U.S. Cl. CPC H02P 25/026; H02P 23/06; H02P 23/14; H02P 25/028; H02P 27/06

(57) ABSTRACT

A device for providing an emergency operating mode of an electric machine, wherein the electric machine is operated with Q different phases that vary between a high-side potential and a low-side potential, where Q≥3. The device is designed to determine au angular value of the electric rotor angle of the electric machine at each point in time from a sequence of consecutive points in time, and, on the basis of the angular value of the electric rotor angle, to determine for each of the Q phases whether the phase should be in a high-side state or in a low-side state. The device is also designed to generate a pulse sequence for each of the Q phases in order to operate the electric machine in the emergency operating mode.

### BACKGROUND AND SUMMARY

The present disclosure relates to a method and to a corresponding device which are designed for operating an electrical machine in an emergency operating mode.

An electrical machine, such as a permanently excited or current excited synchronous motor can be employed e.g. for the propulsion of a motor vehicle (as a traction machine). In the event of a malfunction, it can be necessary to execute an emergency operation of the electrical machine, by which the (electrical) energy of the electrical machine is reduced. An exemplary emergency operating mode is the active short-circuit (ASC) mode in which, by appropriate switching elements, the terminals of the electrical machine are short-circuited, or the free-wheeling (FW) mode, in which the terminals of the electrical machine are decoupled from the energy supply.

In FW operation, energy flows from the electrical machine into the intermediate circuit. If the high-voltage energy store of the motor vehicle (e.g. as a result of an accident or as a result of an abnormal line interruption) is isolated from the intermediate circuit, the intermediate circuit capacitor of the intermediate circuit can be damaged by a relatively high voltage rise. In the event of ASC operation, relatively high transient short-circuit currents can result in damage to the electrical machine (such as e.g. a demagnetization of permanent magnets or thermal damage to the windings and/or to semiconductors).

The effects of FW and/or ASC operation can be addressed by an over-dimensioning of the electrical machine, which over-dimensioning, however, is associated with increased costs, an increased weight, and increased space requirements.

The present document addresses the technical object of providing a particularly efficient and reliable emergency operating mode for an electrical machine.

This object is fulfilled by present disclosure. Advantageous embodiments are described also, inter alia, in the present disclosure. It is hereby observed that additional features of a patent claim which is dependent upon an independent patent claim, in the absence of the features of the independent patent claim, or in combination with only a subset of the features of the independent patent claim, can constitute a standalone invention which is independent of the combination of all the features of the independent patent claim, and which can be the subject matter of an independent claim, of a divisional application or of a subsequent application. In an equivalent manner, the same applies to the technical instruction described in the description, which can constitute an invention which is independent of the features of the independent patent claims.

According to one aspect, a device is described for providing an emergency operating mode of an electrical machine, wherein the electrical machine is operated with Q different phases, each of which varies between a high-side potential and a low-side potential, wherein Q≥3 and, in particular, Q=3. The high-side potential can be e.g. a specific operating voltage, and the low-side potential can be a ground or earth. Alternatively, the high-side potential can be a positive operating voltage and the low-side potential can be a negative operating voltage. The electrical machine can be a permanently excited synchronous machine (PSM). Alternatively, the electrical machine can be an externally excited and/or current excited synchronous machine (EESM or CESM).

The device can be designed to detect a malfunction of the electrical machine and/or of the electric drive system which incorporates the electrical machine. In other words, the device can be designed to detect a malfunction. The malfunction can also involve the electrical machine and/or a component which is associated with the operation of the electrical machine (e.g. the inverter and/or the electrical energy store for the storage of electrical energy for operating the electrical machine). In response to the malfunction thus detected, a changeover from a standard operating mode of the electrical machine to an emergency operating mode of the electrical machine can be executed.

The device is designed (in particular for a time point in a sequence of sequential time points) to ascertain the angular value of the electrical rotor angle of the electrical machine at the respective time point (e.g. on the basis of sensor data from a rotor sensor).

The device is further designed, on the basis of the angular value of the electrical rotor angle, for each of the Q phases, to ascertain whether the respective phase (either) assumes and/or is intended to assume a high-side state or a low-side state. By reference e.g. to a predefined allocation unit for each of the Q phases, it can be ascertained whether the respective phase assumes and/or is intended to assume the high-side state or the low-side state. The allocation unit can be configured, for a multiplicity of (and, in particular, for all the potential) different angular values of the electrical rotor angle, to respectively indicate whether the respective phase assumes and/or is intended to assume the high-side state or the low-side state.

The device is moreover designed, for each of the Q phases, to respectively generate a pulse sequence (for operating the electrical machine). The pulse sequence for one phase can respectively comprise one or more pulses of a respective pulse duration. Moreover, the one or more pulses can be sequentially executed with a given pulse frequency.

The pulses can assume the high-side potential, if the respective phase assumes and/or is intended to assume the high-side state. This can be achieved by closing the high-side switching element of the inverter for the respective phase. Conversely, the pulses can assume the low-side potential, if the phase assumes and/or is intended to assume the low-side state. This can be achieved by closing the low-side switching element of the inverter for the respective phase.

A device is thus described, which generates pulses for the individual phases in an emergency operating mode, the voltage potential of which (in particular the low-side potential or high-side potential) is dependent upon the angular value of the electrical rotor angle. A particularly efficient and reliable emergency operating mode can thus be provided.

The individual pulse sequences can respectively comprise, between two directly sequential pulses, an intermediate interval of a (specific) interval duration. The sum of interval durations and pulse durations can correspond to the reciprocal of the pulse frequency. The device can be designed, in the intermediate interval between two pulses, to respectively execute a free-wheeling operation or a short-circuiting of the Q phases. The Q phases can be decoupled from the high-side potential and from the low-side potential (and, optionally, from one another), in order to execute a free-wheeling operation of the Q phases. Conversely, the Q phases can be mutually coupled, in order to execute a short-circuiting of the Q phases.

By the execution of a free-wheeling operation and/or of a short-circuiting in the intermediate intervals between sequential pulses, the efficiency and reliability of the emergency operating mode can be further enhanced.

The one or more pulses in the pulse sequences of the Q phases are preferably mutually temporally synchronized (and are thus respectively executed simultaneously). The quality of the emergency operating mode can thus be further enhanced.

Pulse sequences of the Q (and, in particular, of the Q=3 phases) can be configured such that the pulse sequences for two different phases respectively comprise simultaneous pulses, both of which assume the high-side potential, or both of which assume the low-side potential.

In particular, pulse sequences of the Q (and, in particular, of the Q=3) phases can be configured such that the pulse sequences for the Q phases respectively comprise simultaneous pulses, of which two respectively assume the high-side potential or (alternatively) of which two respective assume the low-side potential. For example, where Q=3 phases, the simultaneous pulses for two phases can both assume the high-side potential. The temporal pulse for the third phase can then assume the low-side potential. Alternatively, the simultaneous pulses for two phases can both assume the low-side potential. The temporal pulse for the third phase can then assume the high-side potential.

The above-mentioned properties can be valid for all pulses of the pulse sequences (in the emergency operating mode). As a result of pulse synchronization of this type, a particularly reliable emergency operating mode can be provided.

The device can be designed to ascertain one or more operating parameters of the electrical machine at a respective time point wherein, in particular, the one or more operating parameters include the angular velocity of the electrical machine. The pulse frequency and/or pulse duration of the individual pulses can be ascertained according to the one or more operating parameters. By the adaptation of the pulse frequency and/or of the pulse duration to the respective operating state of the electrical machine, the emergency operating mode can be further improved.

Pulse sequences of the Q phases for the overall period [0-2π] of the electrical rotor angle can respectively comprise one or more pulses. The device can be designed to ascertain the pulse frequency such that the pulse sequences of the Q phases for the overall period [0-2π] of the electrical rotor angle respectively comprise 2*Q or more pulses. A particularly reliable emergency operating mode can thus be provided.

The device can be designed to ascertain the polarity of the I_{q} current in a dq coordinate system of the electrical machine (at the respective time point). It can then be ascertained, according to the polarity of the I_{q} current, whether the respective phase assumes and/or is intended to assume the high-side state or the low-side state. By the consideration of the current polarity, the quality of the emergency operating mode can be further enhanced.

According to a preferred example, the following association between the angular value of the electrical rotor angle and the state of the individual phases is employed. The quality of the emergency operating mode can thus be further enhanced.
Where Q=3 and I_{q}<0:
the first phase u, for angular values [9π/12-21π/12] of the rotor angle, assumes the high-side state, and otherwise assumes the low-side state;
the second phase v, for angular values [0-5π/12] and [17π/12-2π] of the rotor angle, assumes the high-side state, and otherwise assumes the low-side state; and/or
the third phase w, for angular values [π/12-13π/12] of the rotor angle assumes the high-side state, and otherwise assumes the low-side state.
Where Q=3 and I_{q}>0:
the first phase u, for angular values [π/4-15π/12] of the rotor angle, assumes the high-side state, and otherwise assumes the low-side state;
the second phase v, for angular values [11π/12-23π/12] of the rotor angle, assumes the high-side state, and otherwise assumes the low-side state; and/or
the third phase w, for angular values [0-7π/12] and [19π/12-2π] of the rotor angle assumes the high-side state, and otherwise assumes the low-side state.

According to a further aspect, a (land-based) motor vehicle (in particular a passenger car, or a heavy goods vehicle, or a bus, or a motorcycle) is described, which motor vehicle comprises the device described in the present document and an electrical machine (e.g. for the propulsion of the vehicle).

According to a further aspect, a method is described for providing an emergency operating mode of an electrical machine. The method comprises the ascertainment of an angular value of an electrical rotor angle of the electrical machine, and an ascertainment, on the basis of the angular value of the electrical rotor angle, for each of the Q phases, as to whether the respective phase assumes and/or is intended to assume a high-side state or a low-side state. The method further comprises the generation of a pulse sequence for each of the Q phases, wherein the pulse sequence for one phase respectively comprises one or more pulses, each having a pulse duration. Moreover, the one or more pulses can occur sequentially, at a pulse frequency. The pulses can assume the high-side potential, if the respective phase assumes and/or is intended to assume the high-side state. Conversely, the pulses can assume the low-side potential, if the phase assumes and/or is intended to assume the low-side state.

The method can be configured to ascertain Q pulse sequences for the corresponding Q phases. On the basis of the angular value of the electrical rotor angle for each of the Q phases, it can thus be ascertained whether the respective phase is intended to assume the high-side state or the low-side state. In other words, on the basis of the angular value of the electrical rotor angle for each of the Q phases, it can be ascertained whether the pulse sequence for the respective phase is intended to comprise one or more pulses having the high-side potential, or (alternatively) one or more pulses having the low-side potential. Corresponding pulse sequences can then be generated (by the closing of corresponding switching elements). In consequence, pulse sequences thus assume the previously ascertained target state (i.e. the high-side state or the low-side state).

It can thus be ascertained, for each of the individual phases, which target state is intended to be in force in the respective phase. It can moreover be achieved (by the generation of a corresponding pulse sequence) that the respective phase assumes the previously ascertained target state. For this reason, in the present document, the terms “assumption of a state” or “in a state” are employed interchangeably with the terms “assumption of an intended state” or “in an intended state”.

According to a further aspect, a software (SW) program is described. The SW program can be designed for running on a computer (e.g. on a control device of a vehicle), in order to execute the method described in the present document.

According to a further aspect, a storage medium is described. The storage medium can comprise a SW program which is designed for running on a processor, in order to execute the method described in the present document.

It should be observed that the methods, devices and systems described in the present document can employed either in isolation, or in combination with other methods, devices and systems described in the present document. Moreover, any aspects of the methods, devices and systems described in the present document can be mutually combined in a variety of ways. In particular, the features of the present disclosure can be mutually combined in a variety of ways. Moreover, features enclosed in brackets are to be understood as optional features.

The present disclosure is described in greater detail hereinafter with reference to exemplary embodiments.

### BRIEF DESCRIPTION OF DRAWINGS

FIG. 1a shows an exemplary inverter for an electrical machine;

FIG. 1b shows an exemplary characteristic of a phase voltage for a standard operating mode;

FIG. 2a shows exemplary angular sectors for a negative cross-phase current I_{q};

FIG. 2b shows exemplary angular sectors for a positive cross-phase current I_{q};

FIG. 3 shows exemplary pulse sequences for the different phases of the electrical machine, within one complete period of the electrical rotor angle;

FIG. 4a shows an exemplary device for operating an electrical machine;

FIG. 4b shows an exemplary device for ascertaining pulse sequences for the different phases of the electrical machine; and

FIG. 5 shows a flow diagram of an exemplary method for providing an emergency operating mode of an electrical machine.

### DETAILED DESCRIPTION OF DRAWINGS

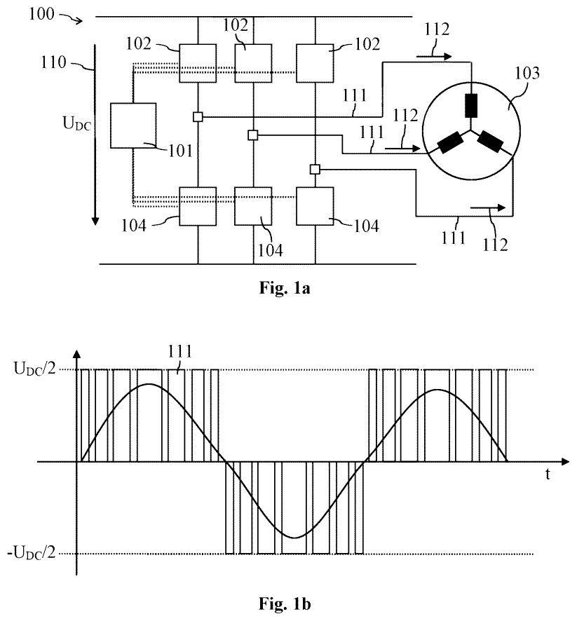

As described above, the present disclosure addresses the provision of a particularly efficient and reliable emergency operating mode for an electrical machine. In this context, FIG. 1a represents an exemplary inverter 100 which is designed, on the basis of a network voltage U_{DC} 110 (i.e. a DC voltage), to generate phase voltages 111 (i.e. AC voltages) for the different phases or windings of an electrical machine 103 (e.g. of a vehicle). The inverter 100 (or power inverter) comprises multiple switches or switching elements 102, 104 which, are respectively arranged in a half-bridge for each phase u, v, w. The switching elements 102, 104 are actuated by a control unit 101, in order to generate phase voltages 111 for the electrical machine 103. It should be observed that, by Clarke and Park transform functions, phase voltages 111 and/or phase currents 112 execute a transition from the u v w coordinate system to the dq coordinate system.

FIG. 1b shows an exemplary phase voltage 111, which can be generated by the switching elements 102, 104 of a half-bridge. As can be seen from FIG. 1b, the switching elements 102, 104 are switched (i.e. opened or closed) in a specific pulse pattern, in order to generate a (sinusoidal) AC voltage 111. The pulse pattern for a specific (static) working point of the electrical machine 103 can be ascertained preliminarily, e.g. using an optimization method, such as e.g. SOPWM, by which a specific optimization criterion (e.g. the harmonic distortion of phase currents) can be optimized and, in particular, can be minimized. Pulse patterns thus ascertained for different working points of the electrical machine 103 can be saved, e.g. in a look-up table (LUT). The individual pulse patterns thus comprise, for each wave or half-wave of the AC voltage which is to be generated, a respective pulse pattern having a specific number of pulses. Different working points of the electrical machine 103 can comprise, e.g. the delivery of different torques and/or the assumption of different speeds of rotation. Operation of the electrical machine 103 with a pulse pattern of this type can be described as a standard operating mode.

In the event of a fault, it may be necessary to operate the electrical machine 103 in an emergency operating mode, in order to reduce the energy of the electrical machine 103. This can be achieved by an ASC operating mode, or by a FW operating mode. As described above, these operating modes can generate relatively high short-circuit currents and/or voltages.

From a short-circuit and free-wheeling simulation, the following conditions for an optimum suppression of transient short-circuit currents and/or for an optimum reduction of electrical energy flowing in the intermediate circuit of the electrical machine 103 or of the inverter 100 can be established (in the dq coordinate system);

$$\vert {U}_{d} \vert = \vert {U}_{q} \vert ; {U}_{d} < 0 ; {U}_{q} > 0 ; {U}_{d} = {U}_{q} ; {U}_{d} < 0 ; {U}_{q} < 0 ; \qquad ( 1 )$$

$$where {I}_{q} < 0 where {I}_{q} > 0$$

On the basis of these conditions, for different angular sectors of the electrical rotor angle, a respective switching pattern is ascertained which executes an optimum suppression of transient short-circuit currents and/or an optimum reduction of energy flowing in the intermediate circuit. In particular, six different angular sectors can be considered, each of which assumes a different switching pattern, as represented exemplarily in Table 1a (for I_{q}<0) and Table 1b (for I_{q}>0).

TABLE 1a
Iq < 0

| Variant | U | V | W | Angular sector |
|---|---|---|---|---|
| 5 | 0 | 1 | 0 | [0-π/12] |
| 6 | 0 | 1 | 1 | [π/12-5π/12] |
| 1 | 0 | 0 | 1 | [5π/12-9π/12] |
| 2 | 1 | 0 | 1 | [9π/12-13π/12] |
| 3 | 1 | 0 | 0 | [13π/12-17π/12] |
| 4 | 1 | 1 | 0 | [17π/12-21π/12] |
| 5 | 0 | 1 | 0 | [21π/12-2π] |

TABLE 1b
Iq > 0

| Variant | U | V | W | Angular sector |
|---|---|---|---|---|
| 1 | 0 | 0 | 1 | [0-π/4] |
| 2 | 1 | 0 | 1 | [π/4-7π/12] |
| 3 | 1 | 0 | 0 | [7π/12-11π/12] |
| 4 | 1 | 1 | 0 | [11π/12-15π/12] |
| 5 | 0 | 1 | 0 | [15π/12-19π/12] |
| 6 | 0 | 1 | 1 | [19π/12-23π/12] |
| 1 | 0 | 0 | 1 | [23π/12-2π] |

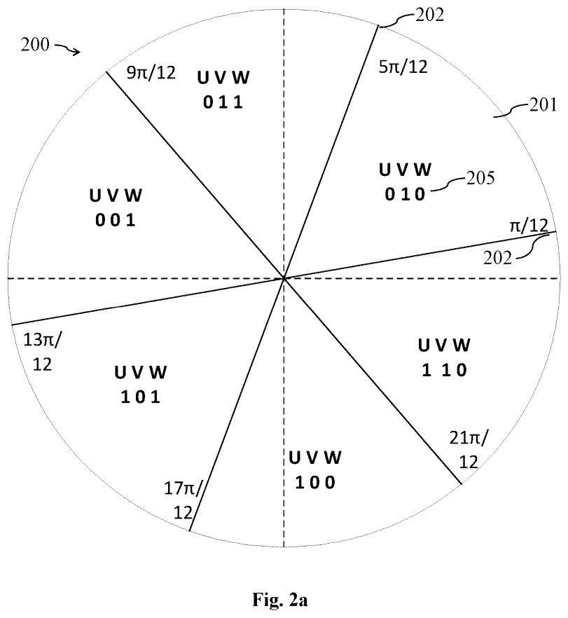

The corresponding angular sectors 201 and switching patterns 205 are also represented in the switching pattern diagrams 200 in FIG. 2a or 2b. In each case, an angular sector 201 thus extends between two angular values 202 of the electrical rotor angle.

The individual phases u, v, w, in the switching patterns 205 can assume either state “0” (i.e. the low-side state) or state “1” (i.e. the high-side state). State “0” indicates that the high-side switching element 102 for the respective phase in the respective angular sector 201 is permanently open. State “0” moreover indicates that the low-side switching element 104 for the respective phase in the respective angular sector 201, at least intermittently (for example for one or more pulses), is closed (in order to generate one or more pulses with the low-side potential).

Conversely, state “1” indicates that the high-side switching element 102 for the respective phase in the respective angular sector 201, at least intermittently (for example for one or more pulses), is closed (in order to generate one or more pulses with the high-side potential). State “1” moreover indicates that the low-side switching element 104 for the respective phase in the respective angular sector 201 is permanently open.

As can be seen from Tables 1a or 1b, for each phase u, v, w, a high-side angular range can be defined in each case, which respectively comprises three angular sectors 201, in which the respective phase assumes state “1” (and in which one or more pulses are generated by the high-side switching element 102). The high-side angular range for phase u (in the case where I_{q}<0) extends over the angular sectors 2, 3 and 4 (see Table 1a). The high-side angular range for phase v (in the case where I_{q}>0) extends over the angular sectors 4, 5 and 6 (see Table 1a). The high-side angular range for phase w (in the case where I_{q}<0) extends over the angular sectors 1, 2 and 6 (see Table 1a).

For each phase, a respective high-side angular range in thus generated, in which the high-side switching element 102 of the respective phase is closed in a pulsed manner, in order to provide a particularly efficient and reliable emergency operating mode.

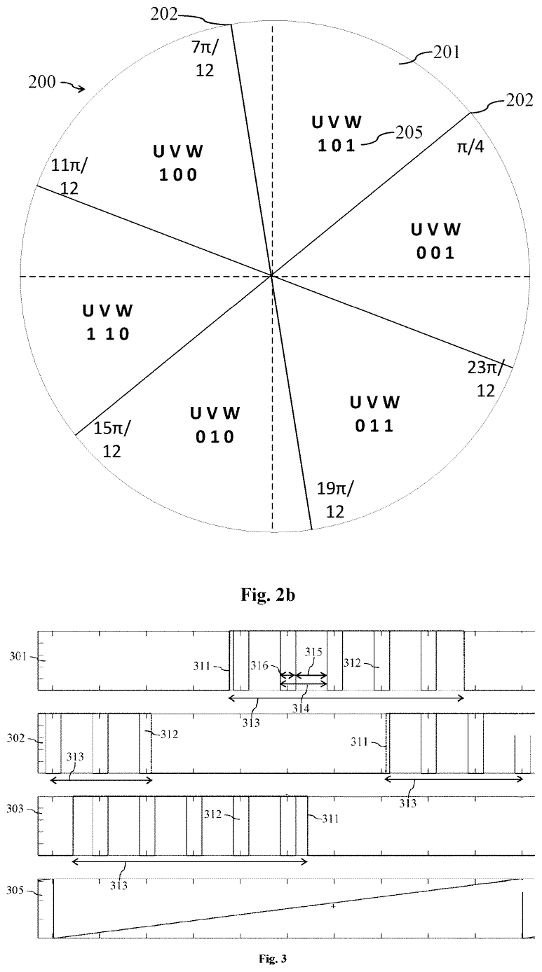

FIG. 3 illustrates the high-side angular ranges 313 for the different phases u 301, v 302 and w 303, for the case where I_{q}<0, and for one complete period (0-2π) of the electrical rotor angle 305. Outside the respective high-side angular range 313, the high-side switching element 102 of the respective phase 301, 302, 303 is permanently open. Within the respective high-side angular range 313, the high-side switching element 102 can be closed in a pulsed manner, as illustrated by the pulses 312. Pulses 312 in the different phases 301, 302, 303 are mutually temporally synchronized. In other words, the pulses 312 in the high-side angular ranges 313 of two different phases 301, 302, 303 are mutually temporally synchronized.

The pulses 312 can be repeated at a specific pulse frequency f. The pulse frequency f can be adjusted in accordance with the angular velocity of the rotor of the electrical machine 103. The pulse frequency f is preferably sufficiently high that, within one complete period of the electrical rotor angle 305, six or more pulses 312 are generated (i.e. at least one pulse 312 per angular sector 201).

Between two directly sequential pulses 312, within an intermediate interval, a free-wheeling operation or, alternatively, a short-circuiting of the phases 301, 302, 303 can be executed. From the pulse frequency f, a pulse period 314 is generated, having a specific period duration T, wherein T=1/f. The pulse duration 316 of the pulse 312 and the interval duration 315 of the intermediate interval, in combination, can exactly define the period duration T. The ratio of the pulse duration 316 to the interval duration 315 can be adjusted, in order to optimize the emergency operating mode.

Thus, in the emergency operating mode, for each phase 301, 302, 303, a respective high-side angular range 313 can be defined, which respectively extends over a specific sub-region of the overall period of the electrical rotor angle 305. It can further be executed that, within the respective high-side angular range 313, voltage pulses 312 (having the high-side potential) at a specific pulse frequency f are generated (by the closing of the respective high-side switching element 102). In the intermediate intervals between the individual pulses 312, a free-wheeling operation or a short-circuiting of the phases 301, 302, 303 can be executed.

Furthermore, in a complementary manner, low-side angular ranges 313 can be defined for the low-side switching element 104 to generate low-side pulses 312 (having the low-side potential) within the respective low-side angular range 313 by the closing of the respective low-side switching element 104. In the intermediate intervals between the individual pulses 312, a free-wheeling operation or a short-circuiting of the phases 301, 302, 303 can be executed. The low-side angular range 313 for one phase 301, 302, 303 corresponds to the angular segments 201 in which the phase 301, 302, 303 assumes the state “0”.

It can be demonstrated that, in the event of free-wheeling (where FW operation of the phases 301, 302, 303 is executed in the intermediate intervals), a rise in the intermediate circuit voltage can be prevented, and a reduction of the intermediate circuit voltage can be achieved. Moreover, the magnitude of transient currents can be limited. In a corresponding manner, it can be demonstrated that, in the event of ASC operation (where ASC operation of the phases 301, 302, 303 is executed in the intermediate intervals), transient short-circuit currents can be substantially reduced (by approximately 60%), and the voltage in the intermediate circuit can be reduced.

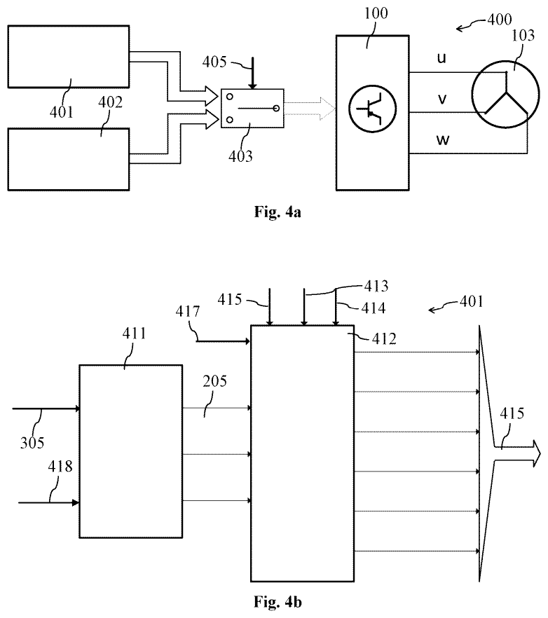

FIG. 4a shows an exemplary device 400 for operating an electrical machine 103. The device 400 comprises an emergency operation module 401 for the emergency operating mode, and a standard module 402 for the standard operating mode. In response to a fault signal 405, a switchover can be executed by the switching unit 403 from the standard operating mode to the emergency operating mode.

FIG. 4b illustrates further details of the emergency operation module 401. In a logic module 411, on the basis of the respective present angular value of the electrical rotor angle 305 (and on the basis of the symbol 418 of the I_{q} current), it can be determined which of the individual phases 301, 302, 303 is situated in a high-side angular range 313 or in a low-side angular range 313. In particular, the switching pattern 205 can be ascertained for the present angular values of the electrical rotor angle 305. To this end, the logic module 411 can comprise a look-up table (e.g. on the basis of Table 1a and/or 1b).

In a pulse generator 412, for the switching pattern 205 thus ascertained, pulse sequences 415 for the individual phases 301, 302, 303, in particular for the switching elements 102, 104 of the individual phases 301, 302, 303 can be ascertained. By a FW/ASC indicator 417, it can be indicated whether a FW or an ASC operation is to be executed in the intermediate intervals between the pulses 312. Moreover, pulse sequences 415 can be generated according to the pulse frequency, or the pulse frequency f 415, and/or according to the ratio 413 of the pulse duration 316 to the interval duration 315. Moreover, an overall duration 414 for the emergency operating mode can be considered.

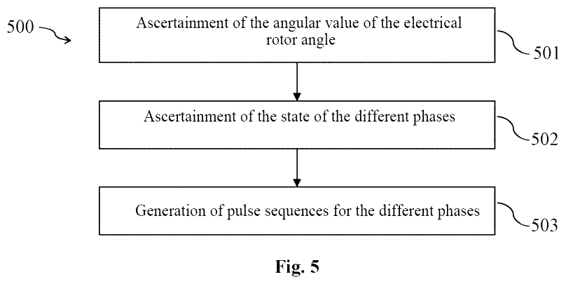

FIG. 5 shows a flow diagram of a (optionally computer-implemented) method 500 for providing an emergency operating mode of an electrical machine 103. The electrical machine 103 is operated with Q different phases 301, 302, 303, which phases vary between a high-side potential (e.g. U_{Dc}/2) and a low-side potential (−U_{DC}/2), wherein Q≥3. In a standard operating mode, by the corresponding operation of an inverter 100, sinusoidal phase voltages 111 and/or phase currents 112 can be generated (as represented in conjunction with FIG. 1a and FIG. 1b). In the emergency operating mode, pulse sequences for the Q phases 301, 302, 303 can be generated by the inverter 100, in order to execute an efficient, reliable and protective reduction of energy which is stored in the electrical machine 103.

The method 500 can be repeated at a sequence of time points. At individual time points, the method 500 can thus comprise the ascertainment 501 of the angular value of the electrical rotor angle 305 of the electrical machine 103 at the respective time point. The angular value can be ascertained by reference to an appropriate sensor of the electrical machine 103.

The method 500 further comprises ascertainment 502, on the basis of the angular value of the electrical rotor angle 305 for each of the Q phases 301, 302, 303, as to whether the respective phase assumes or is intended to assume a high-side state (i.e. state “1”) or a low-side state (i.e. state “0”). This state (i.e. the target state) can be ascertained by reference to Table 1a or 1b, or by reference to FIG. 2a or 2b.

The method 500 moreover comprises the generation 503 of a pulse sequence 415 for each of the Q phases 301, 302, 303. The pulse sequence 415 for one phase 301, 302, 303 can respectively comprise one or more pulses 312, each having a pulse duration 316. The one or more pulses 312 can be sequentially executed at a pulse frequency 415. The pulse frequency 415 and/or the pulse duration 316 can be ascertained e.g. according to the angular velocity of the rotor of the electrical machine 103 at the respective time point.

The individual pulses 312 can assume the high-side potential, if the respective phase 301, 302, 303 respective assumes, or is intended to assume the high-side state. Conversely, the individual pulses 312 can assume the low-side potential, if the phases 301, 302, 303 assume, or are intended to assume the low-side state. In each case, the (temporal) pulses 312 of at least two of the phases 301, 302, 303 can both assume the high-side potential, or can both assume the low-side potential.

By the aspects described in the present document, a particularly efficient and reliable emergency operation of an electrical machine 103 can be enabled.

The present disclosure is not limited to the exemplary embodiments represented. In particular, it should be observed that the description and the figures are only provided by way of an exemplary illustration of the principle of the methods, devices and systems proposed.

1.-12. (canceled)

13. A device for providing an emergency operating mode of an electrical machine, wherein the electrical machine is operated with Q different phases that vary between a high-side potential and a low-side potential, wherein Q≥3, wherein the device is configured to, for a time point in a sequence of sequential time points:
ascertain an angular value of an electrical rotor angle of the electrical machine at the time point;
based on the angular value of the electrical rotor angle for each of the Q phases, ascertain whether the respective phase is intended to assume a high-side state or a low-side state; and
for each of the Q phases, respectively generate a pulse sequence,
wherein the pulse sequence for one phase respectively comprises one or more pulses of a respective pulse duration,
the one or more pulses are sequentially executed with a given pulse frequency;
the pulses assume the high-side potential in response to the respective phase being intended to assume the high-side state; and
the pulses assume the low-side potential in response to the respective phase being intended to assume the low-side state.

14. The device according to claim 13,
wherein the pulse sequences, between two directly sequential pulses, respectively comprise an intermediate interval of an interval duration, and
wherein the device is configured to, in the intermediate interval, respectively execute a free-wheeling operation or a short-circuit of the Q phases.

15. The device according to claim 14,
wherein the device is configured to:
decouple the Q phases from the high-side potential and from the low-side potential to execute the free-wheeling operation of the Q phases, and/or
mutually couple the Q phases to execute the short-circuit of the Q phases.

16. The device according to claim 13,
wherein the one or more pulses of the pulse sequences of the Q phases are mutually temporally synchronized.

17. The device according to claim 13,
wherein the pulse sequences of the Q phases are configured such that:
the pulse sequences for two different phases respectively comprise simultaneous pulses, both of which assume the high-side potential, or both of which assume the low-side potential; and/or
pulse sequences for the Q phases respectively comprise simultaneous pulses, of which two respectively assume the high-side potential or the low-side potential.

18. The device according to claim 13, wherein the device is configured to:
ascertain one or more operating parameters of the electrical machine at a given time point, wherein the one or more operating parameters include an angular velocity of the electrical machine; and
ascertain a pulse frequency and/or a pulse duration according to the one or more operating parameters.

19. The device according to claim 13, wherein the device is configured to:
ascertain a pulse frequency such that the pulse sequences of the Q phases, for one complete period of the electrical rotor angle, respectively comprise 2*Q or more pulses.

20. The device according to claim 13,
wherein the device is configured to, by reference to a predefined allocation unit, for each of the Q phases, ascertain whether the respective phase is intended to assume the high-side state or the low-side state; and
wherein the allocation unit is configured to, for a plurality of different angular values of the electrical rotor angle, respectively indicate whether the respective phase is intended to assume the high-side state or the low-side state.

21. The device according to claim 13, wherein the device is configured to:
ascertain a polarity of an I_{q} current in a dq coordinate system of the electrical machine; and
according to the polarity of the I_{q} current, ascertain whether the respective phase is intended to assume the high-side state or the low-side state.

22. The device according to claim 13,
wherein, where Q=3 and I_{q}<0:
a first phase for angular values [9π/12-21π/12] of the rotor angle, is intended to assume the high-side state, and otherwise to assume the low-side state,
a second phase for angular values [0-5π/12] and [17π/12-2π] of the rotor angle (305), is intended to assume the high-side state, and otherwise to assume the low-side state; and
a third phase for angular values [π/12-13π/12] of the rotor angle is intended to assume the high-side state, and otherwise to assume the low-side state.

23. The device according to claim 13,
wherein, where Q=3 and I_{q}>0:
a first phase for angular values [π/4-15π/12] of the rotor angle, is intended to assume the high-side state, and otherwise to assume the low-side state,
a second phase, for angular values [11π/12-23π/12] of the rotor angle, is intended to assume the high-side state, and otherwise to assume the low-side state, and
a third phase, for angular values [0-7π/12] and [19π/12-2π] of the rotor angle, is intended to assume the high-side state, and otherwise to assume the low-side state.

24. A method for providing an emergency operating mode of an electrical machine, wherein the electrical machine is operated with Q different phases that vary between a high-side potential and a low-side potential, wherein Q≥3, wherein the method, for a time point in a sequence of sequential time points, comprises:
ascertaining an angular value of an electrical rotor angle of the electrical machine at a respective time point;
ascertaining, on a basis of the angular value of the electrical rotor angle, for each of the Q phases, as to whether the respective phase is intended to assume a high-side state or a low-side state; and
generating a pulse sequence for each of the Q phases,
wherein the pulse sequence for one phase respectively comprises one or more pulses, each having a pulse duration,
wherein the one or more pulses occur sequentially at a pulse frequency,
wherein the pulses assume the high-side potential in response to the respective phase being intended to assume the high-side state, and
wherein the pulses assume the low-side potential in response to the phase being intended to assume the low-side state.
